(19) United States
(12) Patent Application Publication
(10) Pub. No.: US 2007/0236011 A1
(43) Pub. Date: Oct. 11, 2007

(54) Telescopic joint with sliding sealing ring

(75) Inventors: Paulo Sergio Freire, Rio de Janeiro (BR); Nelson Patricio Junior, Rio de Janeiro (BR); Wilson Kenzo Huziwara, Rio de Janeiro (BR)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A. - PETROBRAS, Rio de Janeiro (BR)

(21) Appl. No.: 11/783,485

(22) Filed: Apr. 10, 2007

(30) Foreign Application Priority Data
Dec. 1, 2005 (BR) PI 0506285-3

(51) Int. Cl. F16L 27/12

(52) U.S. Cl. 285/302

(57) ABSTRACT

A slip joint is described, with sliding ring and gasket seal, made of metal covered rings with a resilient core that is heat resistant to temperatures up to 600° C., applicable in a solid-gas separation closed cyclonic system in a fluid catalytic cracking unit. The set of gaskets (5) and sliding ring (4) make the differential thermal dilatations, longitudinal and axial, compatible between the concentric outlets, (2a) and (2b), interlinked, and reduces to a minimum the passage of gas and steam through the annular space (3).

### FILED OF THE INVENTION

The present invention relates to a device used in a fluid catalytic cracking unit (FCCU). More specifically, it refers to a telescopic joint, with a sliding ring and gasket seal that allows for longitudinal and axial displacement relative to the concentric outlets, and is especially useful in a closed cyclonic system that combines sealing of the annular space in telescopic joints and the use of external collector pipes in a pseudo-cyclone.

### BACKGROUND OF THE INVENTION

In the petroleum refinery, a fluid catalytic cracking process, after the reaction, the products generated and the catalyst are directed to a separator vessel, in which a cyclonic system operates, usually interlinked cyclones in pairs, to effect the gas-solid separation.

Cyclones are equipments of a geometric layout which make possible the separation of gas-solid mixtures, by centrifuge, due to the great differences in the densities of the components. The gases leave through the top and the solids, which are heavier, drop down, falling into a pipe, called a cyclone leg, which has a device fitted on its end to control the exit of the solids.

In an FCCU that uses a closed cyclonic system, one first cyclone, named pseudo-cyclone, is linked to the arrival nozzle for the gas and catalyst mixture from the riser (reactor). The system is responsible for separating almost all the catalyst from the adsorbed hydrocarbons. However, when small amount of hydrocarbons is dragged by the catalyst and is directed to the interior of the separator vessel, outside of the cyclones, condensation and the generation of coke deposits may occur. For this reason, these gases must be redirected to the inside of the cyclones and returned to the FCCU cracking zone.

Usually, the gases that leave a pseudo-cyclone together with steam from the process are directed to the inside of the cyclones through the annular space that exists in a telescopic joint (10) located between the pseudo-cyclone and the upper cyclone as seen in FIG. 1B.

These gases flow through into the separator vessel of the closed cyclonic systems of an FCCU, mainly above the load in the pseudo-cyclone, leads to the formation of coke in this region. In this case, the undesirable formation of coke may cause emergency down time for a unit, in addition to maintenance down days, in order to perform the difficult procedure of removing the generated coke.

Commonly owned patent application PI0204737-3 teaches a cyclonic system with collector pipes (7) to solve the problem of coke formation in this region of the separator vessel (6) in an FCCU, as shown in FIG. 2A. The system includes at least one external collector tube, connected to the outlet pipe of a pseudo-cyclone (8), said external collector pipe extending parallel from said pseudo-cyclone (8) to a nearby area, preferably above the upper nozzle of said pseudo-cyclone. In this case, the pseudo-cyclone (8) is connected to the first stage cyclone through concentric outlets in a telescopic joint (10) with a sliding ring, as shown in the applicant's patent application PI 9901484, or another commercially available joint with a minimum or null annular space (sealed joint), with the objective of minimizing the passage of gases and steam through it, without structural compromise in the balance due to thermal differential displacements.

The passage of gases and steams through the annular space requires that a telescopic joint with sliding ring, illustrated by FIG. 1A, be manufactured with refractory material covering the entire surface subject to erosion from the impact of particles or it requires rigorous control over the manufacture and size of the material.

Additionally, as well as the formation of coke in the annular space between the concentric outlets can stiffen or lock up a telescopic joint, reduced clearance in the manufacture of the outlets also present similar risks during the operation of an FCCU.

In practice, a telescopic joint (10) with a sliding ring, such as described in the patent application PI 9901484, with a minimum annular space, may still allow the passage of gas into the first stage cyclone, or may generate the possibility of undesirable formation of coke in the separator vessel in an FCCU.

Optionally, a traditional system used to make differential thermal expansion compatible between two lines, pipes or any type of system connected by ducts, without allowing any leaks to occur, is obtained by expansion joints, which may be of various types and forms, as needed in the application. An expansion joint within a solid-gas separator vessel of an FCCU, however, presents drawbacks that, in practice, make their use impractical, such as for example: a) high coke risk in the expansion joint due to the internal dead space it presents; b) high possibility of erosion by the process catalyst due to the expansion joint being manufactured with thickness on the order of 1 mm.

Therefore, in spite of being greatly developed the technique, there is still a need of a telescopic joint with sliding ring that will reduce to a minimum the passage of gases through the annular space within the internal circuit of the cyclones of a gas-solid separator vessel in an FCCU such as is described and claimed as follows. SUMMARY OF THE INVENTION

Broadly, the invention relates to a telescopic joint, with a sliding ring and gasket seal, which makes the differential displacement compatible, both longitudinally and axially, of two concentric outlets of different diameters that are interconnected. Also the invention reduces to a minimum the passage of gases and steam from the outside to the inside of the concentric outlets through the annular space generated around the sliding ring. The gaskets used for sealing the annular space generated between the outlet of smaller diameter and the sliding ring, are manufactured especially for use at temperatures of up to 600° C.

The use of gaskets in the annular space also minimizes the risk of the telescopic joint locking up with the sliding ring.

Even more economically advantageous in comparison to the state of the art, the telescopic joint of this invention may be manufactured of material without anti-erosion refractory properties, which also facilitates control of the manufacture and size of the material.

A telescopic joint thus formed is especially applicable in a fluid catalytic cracking processing unit (FCCU), in which a closed cyclonic system combines the use of telescopic joints and external collector pipes in a pseudo-cyclone.

### BRIEF DESCRIPTION OF THE DRAWINGS

These and other objects and advantages of this invention will be more completely understood taken in conjunction with the accompanying drawings, in which:

FIG. 1A shows a telescopic joint with sliding ring, of the state of the art, made with anti-erosion refractory material on the entire surface of the material, and that allows the passage of gas and steam through the annular space between the sliding ring and the internal outlet;

FIG. 1B shows a cyclonic system, of the state of the art, in the inside of a gas-solid separator vessel of an FCCU;

FIG. 2A shows a pseudo-cyclone, with external collector tubes to optimize the purging of gases inside a separator vessel of an FCCU; and

FIG. 2B shows a telescopic joint with a sliding ring and gasket seal, which is the object of this invention, and the position of a collector pipe of the closed cyclonic system shown in FIG. 2A.

### DETAILED DESCRIPTION OF THE PREFERRED EMBODIMENTS

A telescopic joint is usually used to connect two concentric outlets, (2a) and (2b), of cyclone pairs in the separator vessel (6) of a fluid catalytic cracking process unit—FCCU.

It is known for a telescopic joint with sliding ring, in an FCCU, to allow the controlled passage of gas and free thermal differential expansion, in several directions, between a pseudo-cyclone linked directly to the reactor and a first cyclone, without altering the size of the annular space, which allows a desirable flow rate for the process.

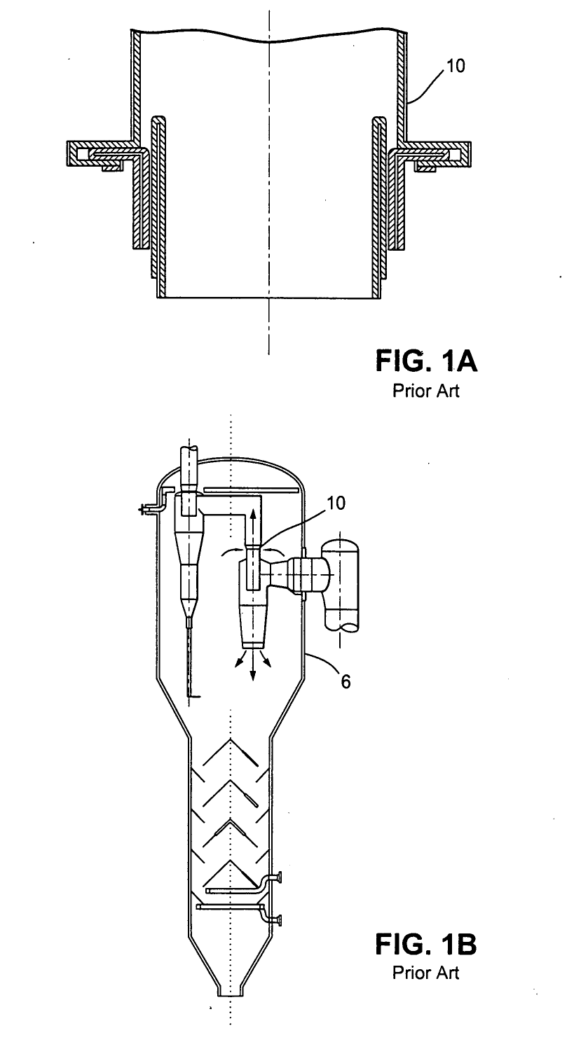

FIG. 1A shows a telescopic joint (10), formed by linking the outlets of cyclones with a sliding ring, that allows a constant area for passage of fluids and balance a known fluid flow rate, such as presented in the applicant's patent PI 9901484 (WO 00/65259), the disclosure of which is incorporated herein by reference.

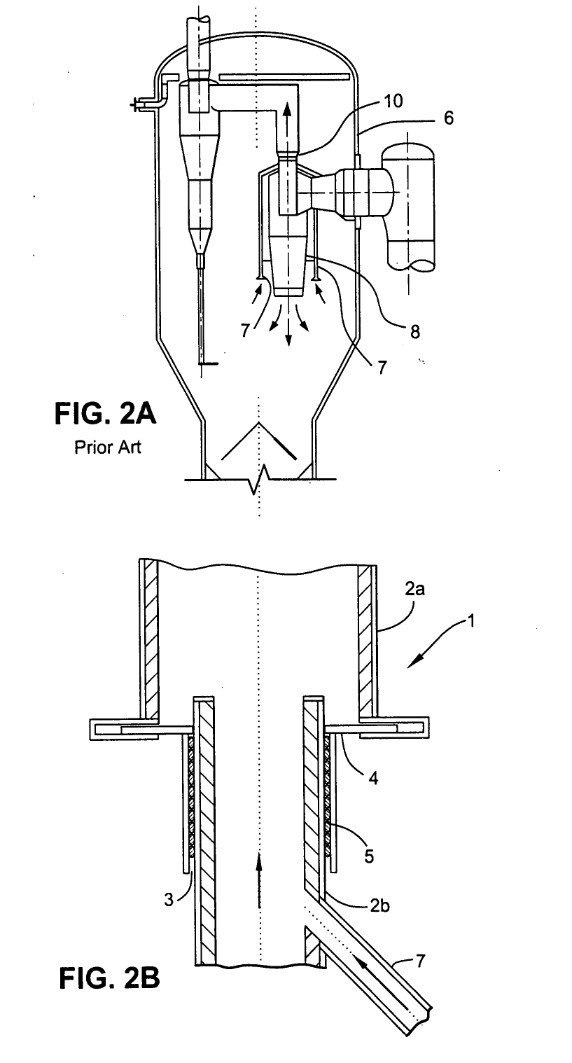

A closed cyclonic system for the gas-solid separation in FCCU is also known to reduce the formation of coke in the separator vessel, and avoids dragging the separated catalyst towards the subsequent stages of cyclones. The system includes a pseudo-cyclone, with external collector tubes that optimize the purge of gases and steam from the separator vessel (6) with a reduction in the residence time for gaseous hydrocarbons within the vessel. As a result, the system avoids overcracking reactions and the formation of coke in the separator vessel (6). FIG. 2A shows detail of a closed cyclonic system, showing a pseudo-cyclone (8), two external collector pipes (7) and a slip joint (10) with sliding ring, such as described in the applicant's patent application PI 0204737 (U.S. application Ser. No. 10/814,641 filed Apr. 1, 2004), the disclosure of which is incorporated herein by reference.

However, in order to make an operation viable by combining the benefits obtained by using a telescopic joint (10) with a sliding ring and by using external collector pipes (7) in a pseudo-cyclone (8), it is necessary to reduce to a minimum the passage of gas and steams through the annular space generated in the joint. This combined benefit is obtained by the telescopic joint (1) of present invention described below, with the aid of FIGS. 2A and 2B.

The configuration of the telescopic joint (1) inside the separator vessel (6) with external collector pipes (7) in a pseudo-cyclone (8) includes: a) two concentric outlets (2a) and (2b), of different diameters, interlinked at their ending, the outlet with the greater diameter (2a) terminating with a seat for inserting a flange and a sliding ring; b) a sliding ring (4) with an L shape, joined to the two concentric outlets, (2a) and (2b), on their endings, that generates an annular space (3) into which the outlet with the smaller diameter (2b) is inserted, and allows the differential displacement of the concentric outlets, (2a) and (2b), caused by the effect of thermal expansion; c) special gaskets (5), that are resistant to high temperatures, that seal the annular space (3) and are compatible with the differential displacement of the concentric outlets, (2a) and (2b), caused by the effect of thermal expansion.

The size of the telescopic joint (1) is a function of the diameters of the concentric outlets, (2a) and (2b), as well as the ratio between the length, height, and thickness of the sliding ring (4).

The gaskets (5), that seal the annular space (3), generated in the interlinking between the concentric outlets, (2a) and (2b), are metal rings covered with resilient material inside, that are resistant to temperatures of up to 600° C., sized in function of the diameter of the concentric outlets, (2a) and (2b), and the annular space (3) generated. The gaskets (5) are placed sequentially in a number of spirals sufficient to fill the entire annular space (3) generated, with a minimum of 6 spirals.

Thus, the gaskets (5) reduce to a minimum the passage of gases and steam through the annular space (3), in such a way that the gases and steam from the separator vessel (6) are directed towards the entrance of the collector pipes (7).

Also, the gaskets (5) make the differential displacement between concentric outlets, (2a) and (2b), compatible, both axially and longitudinally, and minimizes the risk of the telescopic joint (1) locking up the sliding ring (4), in view of the annular space (3) between the outlets (2a) and (2b) could be greater than those mentioned of the state of the art.

Even more advantageous in comparison to the state of the art, the telescopic joint (1) of this invention may be manufactured without anti-erosion refractory material in the annular space (3), once the passage of gas is null, which results in greater ease of manufacture and size control of these components.

The sliding ring (4) is usually made with material equivalent to that specified for the concentric pipes, and the material is not a limiting factor in the implementation of this invention's telescopic joint (1).

The geometry of the telescopic joint (1) with sliding ring and seal has a direct correlation to the process in which it is to be used, in function of the shearing generated by the movement of the interlinked parts, and, as such, avoids down time for maintenance and cleaning when used in an FCCU.

Therefore, the telescopic joint (1), of this invention, makes it viable to use collector pipes (7) in pseudo-cyclones (8) and consequently reduces the formation of coke in the dead zone of a separator vessel (6). It guarantees operational reliability of the closed cyclonic system and avoids the use of joints that have very small annular space which results in mechanical problems during the operation of an FCCU.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

1. Telescopic joint with sliding ring and seal to interlink two concentric pipes of different diameters, at their ends, with one outlet having a greater diameter and terminating with a seat to receive the flange of an L-shaped sliding ring, joined to the two concentric pipes at their endings, and which defines an annular space into which the outlet having a smaller diameter is inserted, comprising special gaskets, that are resistant to high temperatures, placed sequentially in spirals along the annular space, that seal the annular space and make the differential displacement compatible between the concentric pipes both axially and longitudinally, caused by the effect of thermal expansion.

2. Telescopic joint according to claim 1, wherein said gaskets comprise metal rings covered with resilient material resistant to temperatures of up to 600° C.

3. Telescopic joint according to claim 1, wherein said gaskets are of a size that is a function of the size of the annular space and placed sequentially, in a number of spirals sufficient to fill the entire annular space.

4. Telescopic joint according to claim 3, wherein said gaskets are placed in a number of at least 6 spirals.

5. Telescopic joint according to claim 1, wherein the joint is of a size that is a function of the diameters of said pipes.

6. Telescopic joint according to claim 1, wherein the joint links two concentric pipes in a closed cyclonic system for gas-solid separation inside a separator vessel in a FCCU, reducing to a minimum the passage of gases and steam through the annular space.

7. Telescopic joint according to claim 6, wherein the closed cyclonic system for gas-solid separation includes external collector pipes in a pseudo-cyclone.

8. Telescopic joint according to claim 1, wherein the sliding ring is of a size that is a function of the diameters of the concentric outlets.

9. Telescopic joint according to claim 1, wherein the annular space has no anti-erosion refractory material in it.

10. Telescopic joint according to claim 1, wherein the sliding ring is made with a material other than anti-erosion refractory material.

11. Telescopic joint according to claim 1, wherein the sliding ring is made from a material used to form said concentric outlets.
